(19) United States
(12) Patent Application Publication
(10) Pub. No.: US 2005/0062457 A1
(43) Pub. Date: Mar. 24, 2005

(54) Battery charger interface architecture suitable for digital process

(75) Inventors: Fabrice Galant, Cap D'Ail (FR); Pierre Carbou, Tourettes Sur Loup (FR); Philipe Perney, Nice (FR)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 10/665,928

(22) Filed: Sep. 18, 2003

(51) Int. Cl. H02J 7/00

(52) U.S. Cl. 320/128

(57) ABSTRACT

The present application describes a battery charger interface architecture suitable for digital applications. According to some embodiment, the parameters of a battery are measured and converted into a digital data stream using various analog-to-digital conversion techniques. The digital data stream is compared with a predetermined digital reference to control a duty cycle of a PWM sequence according to a functional mode of the battery charger interface. If the battery charger provides a controlled current output, then the battery charger interface architecture operates in a pulse mode controlling the duty cycle of the battery charger current. If the battery charger does not provide a controlled current output, then the battery charger interface architecture operates in a linear mode controlling the charging current of the battery charger.

### TECHNICAL FIELD

The present application describes battery charger interface architecture, and specific embodiments of digital battery charger interface architecture.

### BACKGROUND

Typically, a battery charger interface is configured using analog components such as, for example, high-density resistors, high-voltage transistors, and linear and matched components. The analog battery charger interface requires high precision components to accurately measure the battery parameters such as, current and voltage. Further, the analog battery charger interface requires complex heat dissipation scheme. The heat dissipation scheme can increase the complexity of the software that controls the analog battery charger. Typically, transistors in analog battery charger interfaces are configured for high voltage applications. Thus, typical analog battery charger interfaces may not be suitable for low voltage processes.

### SUMMARY

The present application describes a battery charger interface architecture suitable for digital applications. According to some embodiments, the parameters of a battery are measured and converted into a digital data stream using various analog-to-digital conversion techniques such as, sigma-delta modulation technique. The digital data stream is compared with a digital reference to generate a duty cycle of a battery charger current that is used to charge the battery. The digital reference can be any reference data configured to provide a predetermined or calculated modeled duty cycle for a battery charger. The digital reference can be preprogrammed, calculated, or otherwise dynamically determined by a control software application. The battery charger interface architecture can be configured to adapt to various types of battery chargers. For example, if a battery charger is configured to provide a limited current output, then the battery charger interface architecture can operate in a pulse mode. In the pulse mode, the battery charger controls the charging current for the battery and the battery charger interface architecture controls the duty cycle of the battery charger current. If the battery charger is not configured to provide a limited current output, then the battery charger interface architecture can operate in a linear mode. In the linear mode, the battery charger interface architecture controls the charging current for the battery.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

FIG. 1 illustrates an exemplary architecture of a battery charger interface;

FIG. 2A illustrates an exemplary pulse mode configuration of the battery charger interface using a voltage loop;

FIG. 2B illustrates battery voltage in the exemplary pulse mode configuration of the battery charger interface using the voltage loop;

FIG. 3A illustrates an exemplary linear mode configuration of the battery charger interface using a voltage loop;

FIG. 3B illustrates battery voltage in the exemplary linear mode configuration of the battery charger interface using the voltage loop;

FIG. 4A illustrates an exemplary pulse mode configuration of the battery charger interface using a current loop;

FIG. 4B illustrates the battery voltage in the exemplary pulse mode configuration of the battery charger interface using the current loop;

FIG. 5A illustrates an exemplary linear mode configuration of the battery charger interface using a current loop; and

FIG. 5B illustrates the battery voltage in the exemplary linear mode configuration of the battery charger interface using the current loop.

### DETAILED DESCRIPTION OF THE EMBODIMENTS

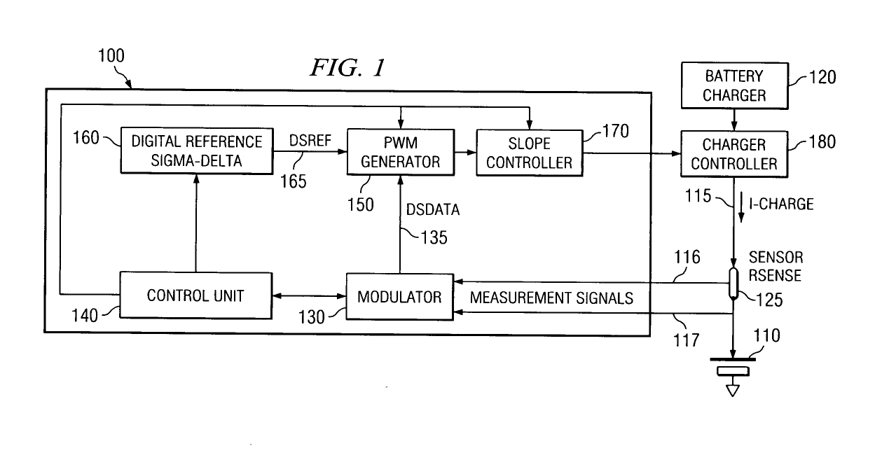

FIG. 1 illustrates an exemplary architecture of a battery charger interface 100 coupled to a battery 110, which is not a part of the battery charger interface 100. The battery 110 is coupled to a charger controller 180 via a link 115. The charger controller 180 can be any device configured to control the output of the battery charger 120, such as a transistor. The link 115 includes a sensor Rsense 125. The sensor Rsense 125 is configured to provide measurement signal for the battery current. The sensor Rsense 125 can be a resistor. The charger controller 180 is coupled to a battery charger 120. A sigma-delta modulator (“modulator”) 130 is coupled to the battery 110 via a link 116 and the sensor Rsense 125. The modulator 130 is also coupled to the battery 110 via an additional link 117. The link 117 can be used to measure the voltage of the battery 110. The modulator 130 receives the analog measurement signals from the battery 110 via the links 116 and 117. The modulator 130 can be any modulator configured to convert the analog measurement signals into digital data Dsdata signal 135. The Dsdata signal 135 represents the measurement signal (current or voltage) for the battery 110. In the present example, the modulator 130 is configured using a sigma-delta modulation technique, however, the modulator 130 can be configured using any modulation technique. Further, the charger controller 180 and the battery charger 120 are not included in the battery charger interface 100; however, the battery charger interface architecture can be configured to include various external elements according to a particular application of the battery charger interface 100.

Typically, a sigma-delta modulation system quantizes the delta (difference) between a current signal and a sigma (sum) of previous signal differences. An integrator within the sigma-delta modulation system quantizes an input signal such as, the measurement signal. The sigma-delta modulation systems are also known as pulse density modulation systems. The sigma-delta modulation systems provide noise shaping for the input signal and combine the sampling at rates well above the Nyquist rate with negative feedback and digital filtering. Typically, the sigma-delta modulation systems are insensitive to circuit imperfections and component mismatch and are thus suitable for digital applications. The modulator 130 can be configured as a current modulator, a voltage modulator, or a combination (current/voltage) modulator. A control unit 140 is coupled to the modulator 130. If the modulator 130 is configured as the combination modulator, then the modulation mode (current or voltage) can be selected using control signals generated by the control unit 140. The control unit 140 can be a microcontroller, a microprocessor, a computing unit, an application specific integrated circuit or any control unit configured to provide the appropriate control signals for the battery charger interface 100.

A Pulse Width Modulation sequence generator (“PWM generator”) 150 is coupled to the modulator 130. The modulator 130 forwards the Dsdata signal 135 to the PWM generator 150. The PWM generator 150 also receives a reference data stream Dsref 165 from a digital reference sigma-delta unit 160 coupled to the PWM generator 150. The reference data stream Dsref 165 can be any digital data stream configured to provide a predetermined or calculated modeled duty cycle for the battery charger 120. For example, when the battery 110 is charged with a constant current, then the modeled duty cycle is configured to allow a regulated charging current from the battery charger 120. And, when the battery 110 is charged with a constant voltage, then the modulated duty cycle is configured to allow a regulated charging voltage for the battery 110. The digital reference sigma-delta unit 160 can be any digital data storage configured to generate the reference data stream Dsref 165. In some embodiments, the control unit 140 can provide the reference data stream Dsref 165 to the PWM generator 150 without using the digital reference sigma-delta unit 160.

The PWM generator 150 compares the reference data stream Dsref 165 and the Dsdata signal 135. Based on the comparison, the PWM generator generates a PWM sequence corresponding to a duty cycle of the charging current of the battery charger 120. For example, if the modulator 130 is configured as a current modulator and the battery 110 is charged in a current mode, then the comparison between the Dsdata signal 135 and the reference data stream Dsref 165 generates a PWM sequence corresponding to a duty cycle for a battery charger current I-charge. And, if the modulator 130 is configured as a voltage modulator and the battery 110 is charged in a voltage mode, then the comparison between the Dsdata signal 135 and the reference data stream Dsref 165 generates a PWM sequence corresponding to a duty cycle for the battery voltage. The reference data stream Dsref 165 can be preprogrammed, calculated, or otherwise dynamically determined. The control unit 140 can be programmed to monitor the battery 110 and adjust the reference data stream Dsref 165 according to the conditions of the battery 110. For example, a heat sensor can be added to the battery 110 to determine the temperature of the battery 110. The control unit 140 can then monitor the temperature of the battery 110 and adjust the reference data stream Dsref 165 accordingly. The control unit 140 can control the charging current based on the temperature of the battery 110 to avoid overheating in the battery 110. Similarly, various other factors can be used to dynamically adjust the reference data stream Dsref 165. The comparison between the reference data stream Dsref 165 and the Dsdata signal 135 can be performed by the control unit 140. For example, the control unit 140 can be programmed to adjust the duty cycle of the PWM sequence generated by the PWM generator to control the current of the battery charger 120.

The PWM generator 150 forwards the PWM sequence to a slope controller 170. The slope controller 170 can be any switched-capacitance RC circuit filter or any other circuit configured to adjust a RC rise time of the PWM sequence. In the present example, the slope controller 150 is configured as a second order switched-capacitance RC circuit. In the pulse mode, the slope controller 170 adjusts the RC rise time of the PWM sequence and provides a fixed RC rise time for the duty cycle of the battery charger 120. In the linear mode, the slope controller averages the PWM sequence to provide a linear control of the current flowing from the charger 120 to the battery 110. The slope controller 170 is coupled to the charger controller 180, which is not a part of the battery charger interface 100; however, the battery charger interface can be configured to include the charger controller 180. The charger controller 180 controls the output current of the battery charger 120 according to the duty cycle generated by the PWM generator 150. The slope controller 170 adjusts the RC rise time of the PWM sequence to match the input requirement of the battery 110. In the present example, the slope controller 170 is configured to provide a RC rise time of the PWM sequence that is suitable for the battery 110; however, the slope controller 170 can be configured to adapt to the requirements of various types of batteries. For example, the slope controller 170 can be configured using various combinations of switched-capacitance RC circuits and the control unit 140 can be programmed to select a specific RC circuit with the required RC rise time for the PWM sequence to match the requirements of a particular battery.

The battery charger interface 100 can be configured to adapt to various functions of the battery charger 120. For example, if the battery charger 120 is configured to control the charging current I-charge, then the battery charger interface 100 can be configured to operate in a pulse mode. If the battery charger 120 is not configured to control the charging current I-charge, then the battery charger interface 100 can be configured to operate in a linear mode. The PWM sequence generated by the PWM generator 150 reflects the appropriate functional mode of the battery charger interface 100. For example, in the pulse mode, the PWM generator 150 generates a PWM sequence corresponding to a duty cycle of the battery charger current such that a predefined charging current can be provided to the battery 110. Because the battery charger 120 controls the charging current I-charge, the charging duty cycle can be controlled according to the battery requirements. The duty cycle of the PWM sequence can be adjusted according to the charging cycle of the battery 110. The slope controller 170 adjusts the RC rising time of the PWM sequence to provide a desired slope for the battery charger current.

In the linear mode, the battery charger 120 does not control the charging current I-charge for the battery 110. The charging current I-charge is regulated by a linear loop configuration of the battery charger interface 100. To provide a regulated charging current during the charging cycle, an averaged DC signal is required for the charger controller 180. The duty cycle of the PWM sequence is averaged to obtain a pulsed or a regulated DC value for the charger controller 180. To obtain the averaged DC signal, the PWM generator generates an accelerated PWM sequence. The slope controller 170 generates the averaged DC signal for the accelerated PWM sequence. The frequency of the accelerated PWM sequence can be determined according to the RC rise time of the slope controller 170. For example, the frequency of the PWM sequence will be relatively lower for a slope controller with a rapid RC rise time; and the frequency of the PWM sequence will be relatively higher for a slope controller with a slower RC rise time. The PWM generator can be configured to generate various frequencies to adapt to the RC rise time of the slope controller 170. For example, the control unit 140 can be programmed to measure the output of the slope controller 170 and adjust the frequency of the PWM generator 150 accordingly. Similarly, if the slope controller 170 is configured using various switch capacitance RC circuits, then the control unit 140 can be programmed to select an optimal combination of the PWM frequency and the switch capacitance RC circuit to generate the required averaged DC signal.

The battery charging current I-charge and the battery voltage can be measured using various means. In the present example, the battery charging current I-charge and the battery voltage are measured using the digital value of the analog measurement signal. The Dsdata signal 135 generated by the modulator 130 can be filtered such as, for example, by using a digital filter between the modulator 130 and the control unit 140. The control unit 140 can be programmed to determine the value of the current I-charge and the voltage of the battery 110 and provide select an appropriate functional mode for the charge cycle.

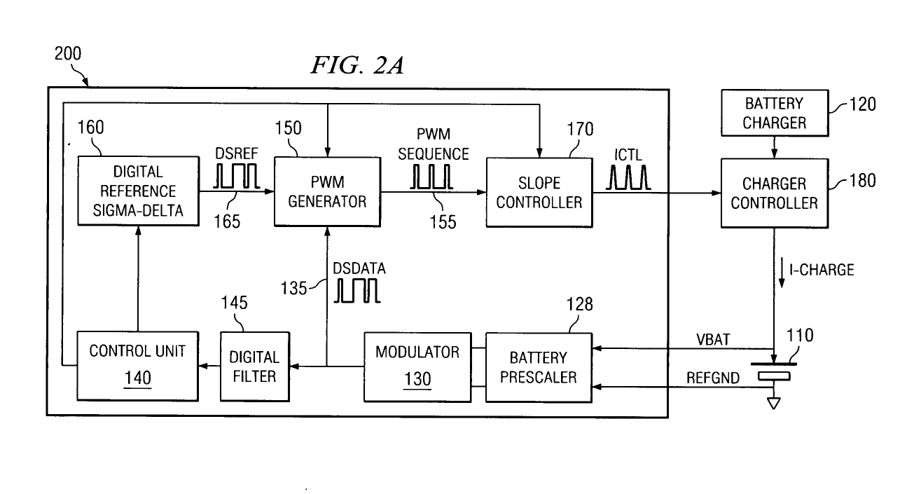

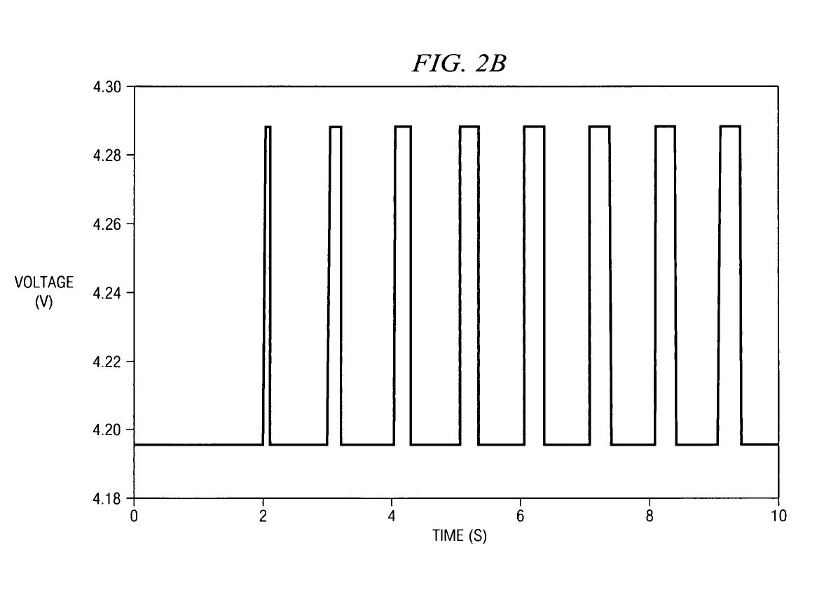

FIG. 2A illustrates an exemplary pulse mode configuration of a battery charger interface 200 using a voltage loop. A battery prescaler 128 is coupled to the modulator 130. The battery prescaler 128 reads a differential analog voltage from the battery 110. The battery prescaler 128 can be a switched-capacitance RC circuit configured to read the differential analog voltage. The differential analog voltage represents a voltage difference between a battery voltage VBAT of the battery 110 and a reference ground voltage REFGND (VBAT−RFGND). The differential analog voltage input is converted into the Dsdada signal 135 by the modulator 130. In the present example, the modulator 130 is configured as a sigma-delta modulator. The battery prescaler 128 can be configured to read the differential analog input signal and adjust the signal levels accordingly to match the input requirements of the modulator 130.

A digital filter 145 is coupled to the modulator 130. The digital filter 145 is configured to filter the Dsdata signal 135 and determine the battery voltage. The control unit 140 reads the battery voltage data and provides appropriate controls to various units as described herein. The PWM generator 150 compares the Dsdata signal 135 and the reference data stream Dsref 165 generated by the digital reference sigma-delta 160. Based on the comparison, the PWM generator 150 generates a PWM sequence 155 representing the duty cycle for the battery charger 120. In the pulse mode, because the battery charger 120 controls the charging current for the battery 110, the PWM sequence 155 is a slow sequence matching the RC rise time of the slope controller 170 and corresponding to a charging duty cycle of the battery charger 120. The slope controller 170 provides a fixed RC rise time for the PWM sequence 155 and generates a corresponding control sequence ICTL for the charger controller 180. The charger controller 180 uses the control signal ICTL to control the duty cycle of the battery charger 120.

FIG. 2B illustrates the battery voltage VBAT of the battery 110 in the exemplary pulse mode configuration of the battery charger interface 200 using the voltage loop. In the pulse mode, the battery charger 120 controls the charging current I-charge and the PWM generator 150 generates a relatively slower PWM sequence 155. In the present example, a one hertz sequence is generated for the duty cycle of the battery charger current I-charge. However, the duty cycle of the PWM sequence 155 can be adjusted according to the battery charging requirement and the maximum charging current provided by the battery charger 120. For example, if the battery charger 120 provides a lower charging current, then the duty cycle of the PWM sequence 155 can be adjusted to provide a longer pulse width for the battery charger current I-charge so that a regulated charging duty cycle can be provided for the battery 110.

The voltage VBAT of the battery 110 includes the charge of the battery 110 and a voltage generated by the charging current I-charge in combination with a series resistance R-bat of the battery 110. For example, if the battery 110 has a charge V-charge and the series resistance R-bat, then the measured battery voltage VBAT is given as:
VBAT=V-charge+(I-charge*R-bat)
In the pulse mode, the battery voltage VBAT and the charging current I-charge follow the PWM sequence 155. The PWM sequence 155 can be adjusted according to the charging duty cycle of the battery 110. As the charge in the battery 110 increases, the corresponding charging current I-charge decreases. For example, when the battery voltage VBAT is at a maximum level, then a minimum charging current flows to the battery 110 and when the battery voltage VBAT is at a lowest level, then a maximum charging current flows to the battery 110. The PWM generator 150 adjusts the duty cycle of the PWM sequence 155 accordingly.

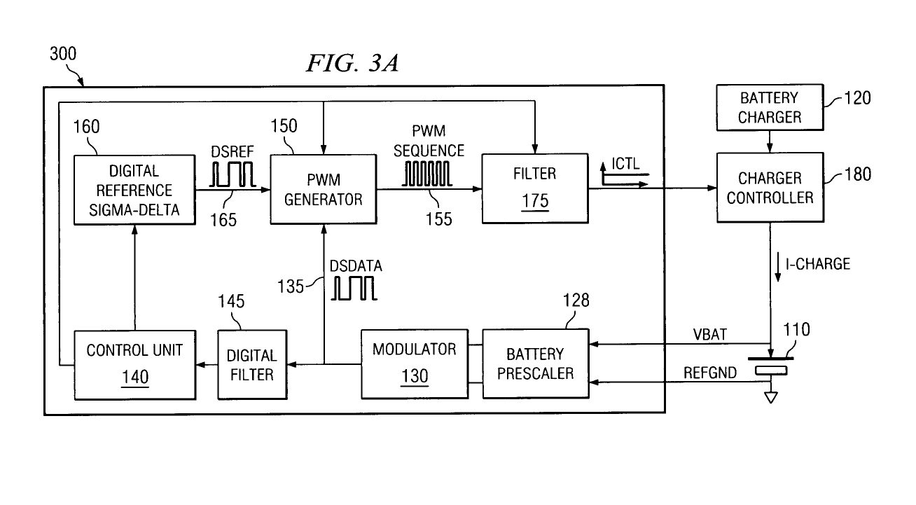

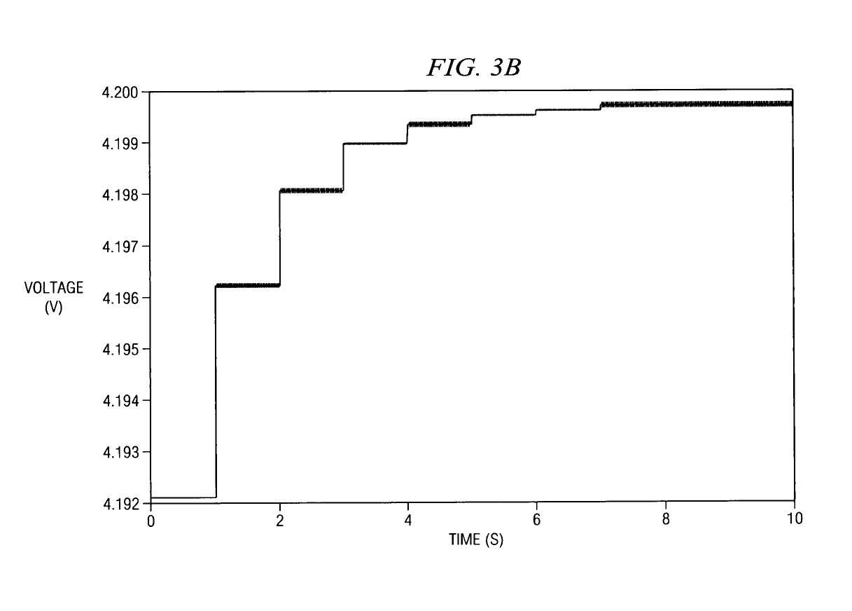

FIG. 3A illustrates an exemplary linear mode configuration of a battery charger interface 300 using a voltage loop. In the linear mode, the battery charger 120 does not control the charging current I-charge. The charging current I-charge is controlled by the battery charger interface 300. For example, if the charger controller 180 is configured as a transistor to provide the regulated charging current, then a DC input signal is required for the charger controller 180. To generate the DC input signal for the charger controller 180, the PWM generator 150 generates an accelerated PWM sequence 155. The frequency of the PWM sequence 155 can be adjusted according to the RC rise time of a filter 175 that is coupled to the PWM generator 155. The filter 175 filters the PWM sequence 155 and generates an averaged regulated DC signal ICTL for the PWM sequence 155. The filter 175 and the slope generator 170 can be configured as a single unit. The duty cycle of the PWM sequence 155 is averaged by the filter 175 to obtain the regulated DC signal ICTL for the charger controller 180. The filter 175 can be configured to provide various RC rise times. The control unit 140 can be programmed to select appropriate RC rise time of the filter 175 and adjust the PWM sequence 155 accordingly to provide the averaged regulated DC signal ICTL. The value of the averaged regulated DC signal ICTL is regulated according to the input requirement of the battery voltage.

FIG. 3B illustrates the battery voltage VBAT of the battery 110 in the exemplary linear mode configuration of the battery charger interface 300 using the voltage loop. In the linear mode, the battery charger 120 does not control the charging current I-charge for the battery 110. As in the pulse mode of the voltage loop configuration, the battery voltage VBAT in the liner mode also includes the battery charge and the voltage generated by the I-charge in combination with a series resistance R-bat of the battery 110. Because the battery charger interface 300 provides a regulated DC signal for the battery voltage VBAT, a limited charging current I-charge flows to the battery 110. In the present example, after a loop rapidity time delay, the battery voltage VBAT reaches a regulated value representing a sum of the battery charge and the voltage drop across the battery resistor R-bat.

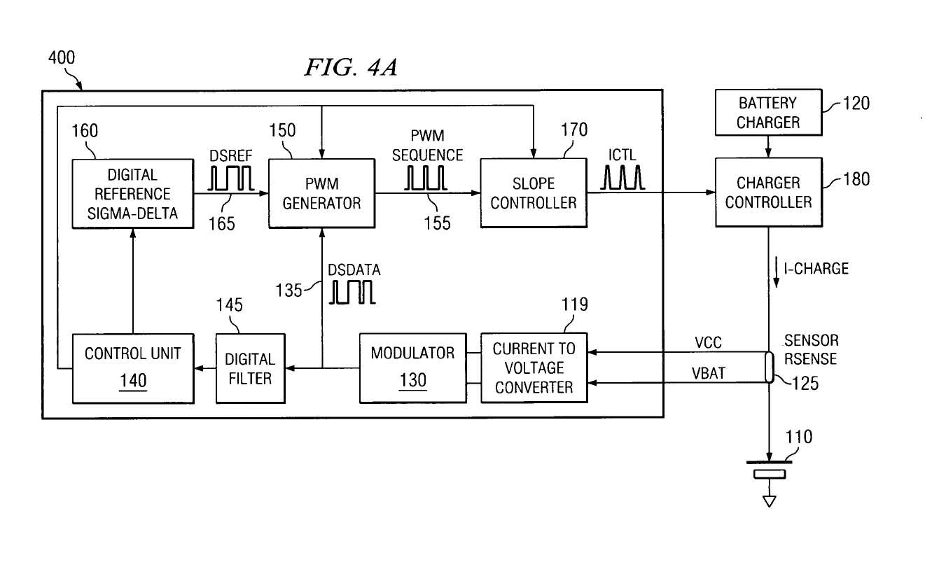

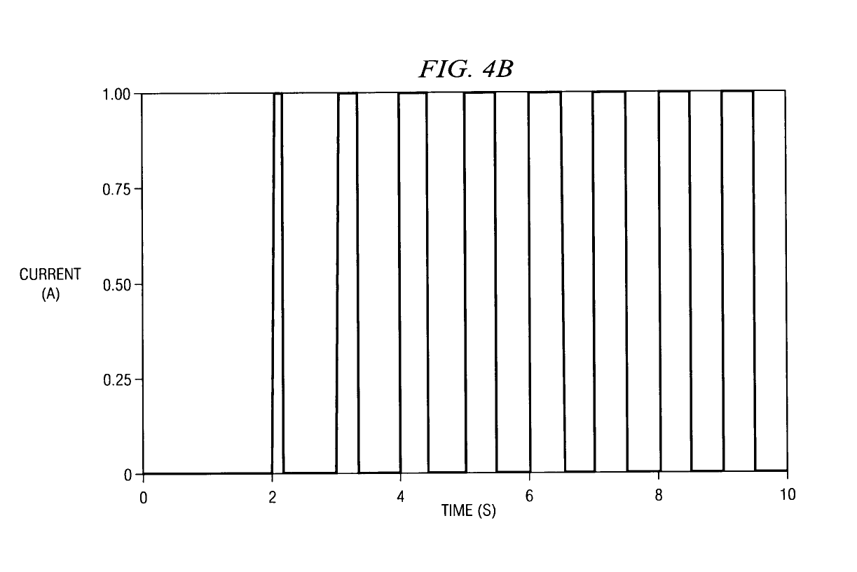

FIG. 4A illustrates an exemplary pulse mode configuration of a battery charger interface 400 using a current loop. A current-to-voltage converter 119 is coupled to the modulator 130. The current-to-voltage converter 119 reads a differential analog input from the sensor Rsense 125 (Rsense*I-charge) and converts the differential analog input into a voltage data. In the present example, the current-to-voltage converter 119 is configured using a switched-capacitance RC circuit. The modulator 130 converts the differential analog input into the Dsdata signal 135. The PWM generator 150 compares the Dsdata signal 135 and the reference data stream Dsref 165 and generate a PWM sequence 155 corresponding to the duty cycle of the battery charger current. In the pulse mode, the battery charger 120 controls the charging current I-charge for the battery 110. The slope controller 170 adjusts the RC rise time of the PWM sequence 155 and provides a fixed RC rise time for the PWM sequence 155 according to the input requirements of the battery 110. The slope controller 170 generates the control sequence ICTL for the charger controller 180. The charger controller 180 uses the control sequence ICTL to control the duty cycle of the battery charger current I-charge.

FIG. 4B illustrates the charging current I-charge in the exemplary pulse mode configuration of the battery charger interface 400 using the current loop. In the pulse mode, the battery charger 120 controls the charging current I-charge. The charging current I-charge follows the PWM sequence 155. The PWM sequence 155 can be adjusted to provide a regulated duty cycle for the battery charger current to provide the regulated charging current for the battery 110. The slope controller 170 adjusts the RC rise time of the PWM sequence and generates the control sequence ICTL for the charger controller 180. In the present exemplary current loop configuration, the charging current I-charge is given as:
I-charge=ICTL*Gain
where the Gain is generated by the semiconductor electronic components used in various elements of the battery charger interface 400.

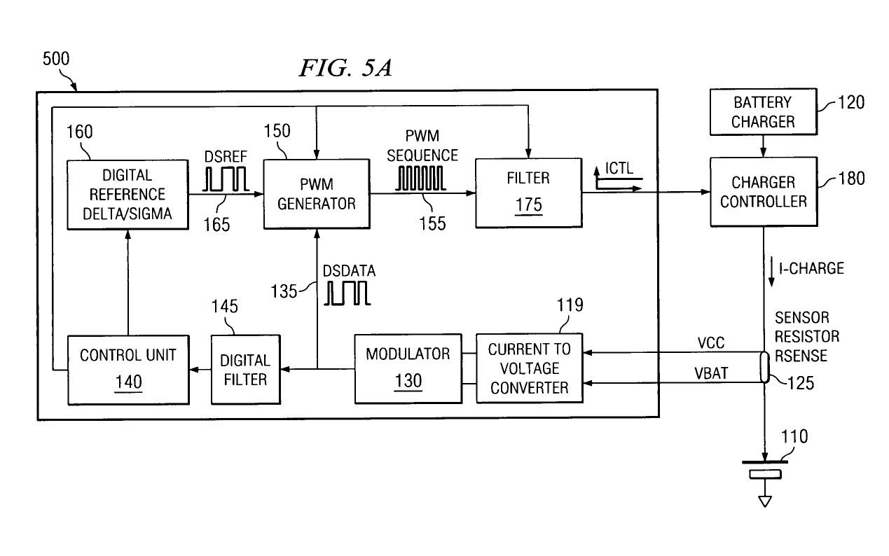

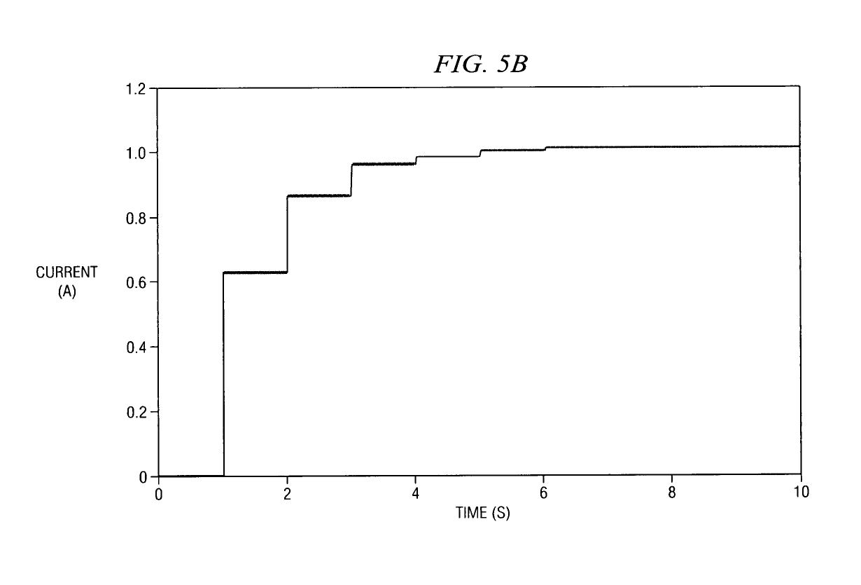

FIG. 5A illustrates an exemplary linear mode configuration of a battery charger interface 500 using a current loop. In the linear mode, the battery charger 120 does not control the charging current I-charge for the battery 110. The PWM generator 150 compares the Dsdata signal 135 and the reference data stream Dsref 165 and generates an accelerated PWM sequence 155. The accelerated PWM sequence 155 is averaged by the filter 175 to generate a regulated DC signal ICTL. The level of the regulated DC signal ICTL is used by the charger controller 180 to provide the regulated charging current I-charge for the battery 110. The frequency of the PWM sequence 155 can be adjusted according to the RC rise time of the filter 175 such that the average DC signal generated by the filter 175 can provide the regulated charging current flow to the battery 110.

FIG. 5B illustrates the charging current in the exemplary linear mode configuration of the battery charger interface 500 using the current loop. In the linear mode, the battery charger 120 does not control the charging current I-charge. For a transistor based charger controller, a DC signal is required to provide the regulated charging current for the battery 110. To generate the DC signal, the filter 175 averages the PWM sequence 155. The frequency of the PWM sequence 155 can be adjusted according to the RC rise time of the filter 175. In the present example, the charging current I-charge reaches the regulated value after a loop rapidity time delay. The charging current I-charge is an averaged value of the PWM sequence 155. The PWM sequence 155 can be adjusted according to the regulated current requirement of the battery 110.

A few preferred embodiments have been described in detail herein. It is to be understood that the scope of the invention also comprehends embodiments different from those described, yet within the scope of the claims. Words of inclusion are to be interpreted as nonexhaustive in considering the scope of the invention. While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

The section headings in this application are provided for consistency with the parts of an application suggested under 37 CFR 1.77 or otherwise to provide organizational cues. These headings shall not limit or characterize the invention(s) set out in any patent claims that may issue from this application. Specifically and by way of example, although the headings refer to a “Field of the Invention,” the claims should not be limited by the language chosen under this heading to describe the so-called field of the invention. Further, a description of a technology in the “Description of Related Art” is not be construed as an admission that technology is prior art to the present application. Neither is the “Summary of the Invention” to be considered as a characterization of the invention(s) set forth in the claims to this application. Further, the reference in these headings to “Invention” in the singular should not be used to argue that there is a single point of novelty claimed in this application. Multiple inventions may be set forth according to the limitations of the multiple claims associated with this patent specification, and the claims accordingly define the invention(s) that are protected thereby. In all instances, the scope of the claims shall be considered on their own merits in light of the specification but should not be constrained by the headings included in this application.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

1. A method for charging a battery using a battery charger interface, the method comprising:
generating an analog measurement signal corresponding to one or more parameters of the battery;
converting the analog measurement signal into digital data;
comparing the digital data with a digital reference corresponding to a predetermined duty cycle of a battery charger; and
based on the comparison, generating a pulse width modulation sequence according to a functional mode of the battery charger interface.

2. A method according to claim 1, wherein the pulse width modulation sequence corresponds to a charging duty cycle of the battery charger.

3. A method according to claim 1, wherein one of the one or more parameters is the battery voltage.

4. A method according to claim 1, wherein one of the one or more parameters is the battery current.

5. A method according to claim 2, wherein the one or more parameters of the battery are measured using one of a current loop or a voltage loop.

6. A method according to claim 5, wherein the functional mode of the battery charger interface is a pulse mode.

7. A method according to claim 6, further comprising:
adjusting an RC rise time of one or more pulses of the pulse width modulation sequence; and
charging the battery according to the charging duty cycle, wherein the RC rise time of the pulse width modulation sequence is adjusted according to an input requirement of the battery.

8. A method according to claim 5, wherein the functional mode of the battery charger interface is a linear mode.

9. A method according to claim 8, further comprising:
filtering the pulse width modulation sequence to generate an averaged DC signal;
using the averaged DC signal to generate a regulated charging current from the battery charger; and
charging the battery according to the charging duty cycle, wherein the battery is charged using the regulated charging current.

10. A method according to claim 1, further comprising:
filtering the digital data.

11. A method according to claim 1, wherein the one or more parameters are measured using a differential analog input.

12. A method according to claim 1, wherein the digital reference is predetermined.

13. A method according to claim 1, wherein the digital reference is dynamically determined.

14. A method according to claim 1, wherein the analog measurement signal is converted into the digital data using a sigma-delta modulation.

15. An architecture for a battery charger interface comprising:
a battery parameter measurement element configured to measure analog measurement signals corresponding to one or more parameters of a battery;
an analog-to-digital converter coupled to the battery parameter measurement element and configured to convert the analog measurement signals into digital data; and
a pulse width modulation sequence generator coupled to the analog-to-digital converter and configured to:
compare the digital data with a digital reference corresponding to a duty cycle of a charging current for the battery; and
based on the comparison, generate a pulse width modulation sequence according to a functional mode of the battery charger interface.

16. An architecture according to claim 15, further comprising:
a battery charger coupled to the battery and configured to generate the charging current; and
a digital reference unit coupled to the analog-to-digital converter and configured to generate the digital reference.

17. An architecture according to claim 15, further comprising:
a digital filter coupled to the analog-to-digital converter and configured to filter the digital data.

18. An architecture according to claim 16, further comprising:
a slope controller coupled to the pulse width modulation sequence generator and configured to adjust an RC rise time of one or more pulses of the pulse width modulation sequence; and
a charger controller coupled to the battery charger and configured to control the charging current of the battery charger, wherein the RC rise time of the pulse width modulation sequence is adjusted according to an input requirement of the battery.

19. An architecture according to claim 15, wherein the one or more parameters are measured using one of a current loop or a voltage loop.

20. An architecture according to claim 19, wherein the functional mode of the battery charger interface is a pulse mode.

21. An architecture according to claim 19, wherein the functional mode of the battery charger interface is a linear mode.

22. An architecture according to claim 21, wherein the slope controller is further configured to
filter the pulse width modulation sequence to generate an averaged DC signal.

23. An architecture according to claim 15, wherein the analog measurement signals are measured using a differential analog input.

24. An architecture according to claim 15, wherein one of the one or more parameters is the battery voltage.

25. An architecture according to claim 15, wherein one of the one or more parameters is the battery current.

26. An architecture according to claim 15, wherein the digital reference is predetermined.

27. An architecture according to claim 15, wherein the digital reference is dynamically determined.

28. An architecture according to claim 15, wherein the analog measurement signals are converted into the digital data using a sigma-delta modulation.
